(19) United States
(12) Patent Application Publication
(10) Pub. No.: US 2022/0261856 A1
(43) Pub. Date: Aug. 18, 2022

(54) METHOD FOR GENERATING SEARCH RESULTS IN AN ADVERTISING WIDGET

(71) Applicant: LIMITED LIABILITY COMPANY "SARAFAN TEKHNOLOGII", St. Petersburg (RU)

(72) Inventors: Andrej Vladimirovich KORHOV, St. Petersburg (RU); Aleksej Nikolaevich ARHIPENKO, St. Petersburg (RU); Mihail Aleksandrovich BEBISHEV, Krasnoyarsk (RU)

(21) Appl. No.: 17/627,610

(22) PCT Filed: Oct. 16, 2019
(86) PCT No.: PCT/RU2019/000741

§ 371 Date: Jan. 14, 2022

(51) Int. Cl. G06Q 30/02; G06Q 30/06; G06N 3/08

(52) U.S. Cl. CPC G06Q 30/0277; G06N 3/08; G06Q 30/0641; G06Q 30/0603

(57) ABSTRACT

The present technical solution relates to the field of computing, and more particularly to a method for generating search results in an advertising widget. The technical result consists in the reliable recognition of objects from a contextual display site for the purpose of automatically searching for relevant goods in electronic store catalogues. A computerized method for generating search results in an advertising widget consists in carrying out the following steps with the aid of at least one neural network: receiving an image and a textual description obtained from a contextual display site; processing the obtained image of an area under examination by detecting objects on the image and extracting features of the objects on the image; analyzing the extracted features and, on the basis of said analysis, extracting detected objects for classification; extracting features of the textual description; using the features of the objects on the image and the features of the textual description to calculate vectors corresponding to the objects in a semantic space; using the resulting combination of vectors to search for relevant goods in electronic store catalogues; generating search results in an advertising widget.

### FIELD OF THE INVENTION

This technical solution relates to the field of computing, in particular, to a method for generating search results in an advertising widget.

### BACKGROUND

A similarity ranking system and its use in recommender systems is known in the prior art, which is disclosed in the patent application WO2018/148493A1, publ. 16 Aug. 2018.

The disadvantage of this solution is that it does not use a detector before using the neural network to calculate the vector representation. The use of the detector gives a significantly better quality vector representations due to clipping off the background and other objects that may be present in the image. Besides, the triplet generation method of this solution is based on using a random object as a negative example without further specifying how this random object is selected. If one just chooses an arbitrary random object, then learning will be extremely ineffective. Most triplets will be classified correctly at early stages of learning and will not give any gain in the quality of the vector representation. At the same time, the learning effectiveness will be substantially slowed down.

Besides, the significant disadvantage of the known solution is that it recognizes images only, but text descriptions are ignored.

### SUMMARY OF THE INVENTION

This technical solution is aimed at elimination of the disadvantages inherent in the existing solutions.

The technical problem, for solving of which the claimed technical solution is intended, is creation of the computer-implementable method for generating search results in an advertising widget, which is characterized in the independent claim.

Additional embodiments of this invention are presented in the dependent claims.

The technical result consists in the reliability of object recognition from a contextual media site for automatic searching relevant goods in electronic store catalogs.

In a preferred embodiment it is claimed as follows:

a computer-implemented method for generating search results in an advertising widget, which consists in performing the steps at which by use of at least one neural network (NN):
receiving the image and textual description obtained from the contextual media site;
processing the obtained image of the investigated area by detecting objects in the image, extracting the object features in the image;
analyzing the extracted features, and based on the analysis, selecting the detected objects for dividing them into classes;
extracting the features of a textual description;
computing the vectors corresponding to the objects in the semantic space by use of object features in the image and features of the textual description;
using the obtained combination of vectors for searching relevant goods in electronic store catalogs;
generating search results in an advertising widget.

In a particular embodiment the detected objects are selected by means of bounding boxes.

In the other particular embodiment the original image features that are not related to the selected object are suppressed by selecting the contoured object.

In the other particular embodiment the classifiers are formed at the learning step using a learning sample, generating optimal classifiers.

In the other particular embodiment a neural network with Mask R-CNN architecture is used to analyze the extracted features.

In the other particular embodiment a triplet-learned neural network is used to compute a vector in the semantic space.

In the other particular embodiment, a neural network is additionally used to classify the image quality.

In the other particular embodiment relevant products are displayed to the user with ability to go to a specific product page for purchasing.

### DESCRIPTION OF THE DRAWINGS

Implementation of the invention will be further described in accordance with the attached drawings, which are presented to clarify the invention chief matter and by no means limit the field of the invention. The following drawings are attached to the application:

FIG. 1 illustrates a computer-implemented method for generating search results in an advertising widget;

FIG. 2 illustrates a scheme for analyzing content from a contextual media site;

FIG. 3 illustrates a scheme for goods catalog analysis;

FIG. 4 illustrates the claimed solution structure;

FIG. 5 illustrates the example of the computer device schematic diagram.

### DETAILED DESCRIPTION OF THE INVENTION

Numerous implementation details intended to ensure clear understanding of this invention are listed in the detailed description of the invention implementation given next. However, it is obvious to a person skilled in the art how to use this invention as with the given implementation details as without them. In other cases, the well-known methods, procedures and components have not been described in details so as not to obscure unnecessarily the present invention.

Besides, it will be clear from the given explanation that the invention is not limited to the given implementation. Numerous possible modifications, changes, variations and replacements retaining the chief matter and form of this invention will be obvious to persons skilled in the art.

Concepts and terms necessary to understand this technical solution are described below.

Artificial neural network (hereinafter ANN) is a computational or logical circuit built from homogeneous processing elements, which are simplified functional neuron models.

Neuron is an individual computational element of a network; each neuron is connected to the neurons of the previous and next layer of the network. When an image, video or audio file arrives at the input, it is sequentially processed by all network layers. Depending on the results, the network can change its configuration (connection weights, offset values, etc.).

Currently, artificial neural networks are important tools for solving many applied problems. They have already made it possible to cope with a number of difficult problems and promise creation of new inventions capable of solving problems that only a person can do so far. Artificial neural networks, just like biological ones, are systems consisting of a huge number of functioning processors-neurons, where each of them performs some small amount of work assigned to it, while having a large number of connections with the others, which characterizes the power of network computing.

Widget is a small graphic element or module inserted into a website or displayed on the desktop to display important and frequently updated information.

Contextual-media site is a system for placing contextual advertising and advertising that takes into account the interests of users on the pages of the partner network participating sites.

The present invention is to provide a computer-implemented method for generating search results in an advertising widget.

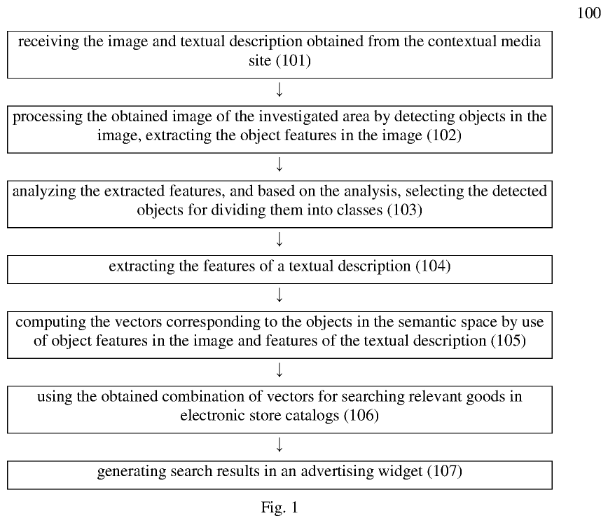

As detailed below in FIG. 1, the claimed computer-implemented method (100) is implemented as follows:

At step (101) receiving image and textual description obtained from the contextual media site.

At step (102) processing the obtained image of the investigated area by detecting objects in the image, extracting object features in the image.

Then, at step (103), analyzing the extracted features, and based on the analysis, selecting the detected objects for dividing them into classes.

After that, at step (104), extracting the features of a textual description.

At step (105) computing the vectors corresponding to the objects in the semantic space by use of object features in the image and features of the textual description. At step (106) using the obtained combination of vectors for searching relevant goods in electronic store catalogs.

And at step (107) generating search results in an advertising widget.

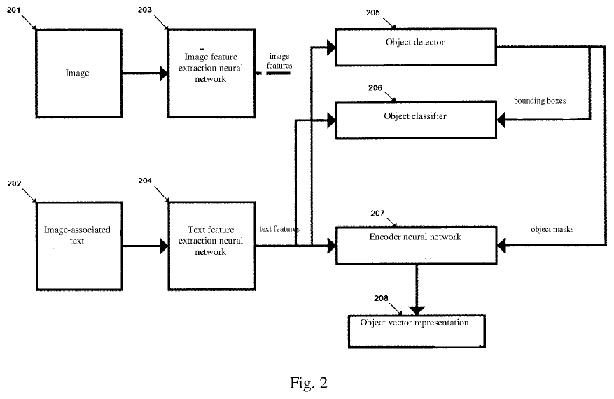

FIG. 2 illustrates a scheme for analyzing content from a contextual media site, where at the first step it is performed as follows:
1. Getting an image (201) from the site;
2. Extracting image features using a neural network (203);
3. Analyzing the extracted features by the object detection neural network (205);
4. Selecting objects with bounding boxes;
5. Selecting the contoured objects (masks).

At the second step, analyzing the text associated with the image is (article text, image description):
1. Obtaining image-associated text (202) (eg. an image caption, text, or article title);
2. Extracting text features using a neural network (204).

At the third step, obtaining the result based on the results of the first and second step processes:
1. Analyzing the extracted features by the classification neural network (206);
2. Computing the object features by use of the encoder neural network (207);
3. Object vector representation (208).

Thus, resulting from the analysis of the contextual media site for each image, a set of objects is obtained, each of which is characterized by its own class and vector representation.

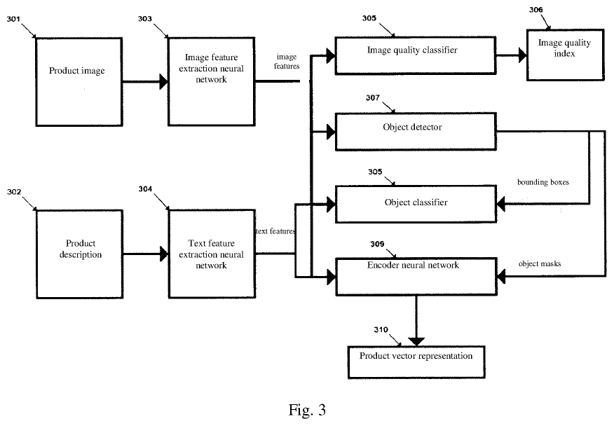

FIG. 3 illustrates a scheme for goods catalog analysis, where, at the first step the image in the goods catalog is analyzed:
1. Getting an image (301) from the catalog;
2. Extracting image features (303);
3. Determining image quality by a neural network (305);
4. Assigning a class depending on the image quality;
5. Detecting objects in the image by means of the object detector (307);
6. Selecting objects with bounding boxes;
7. Selecting the contoured objects (masks).

At the second step, analyzing the text associated with the image is (article text, image description):
1. Getting image-associated text (302) (for example, product name, description or characteristics);
2. Extracting text features using a neural network (304).

At the third step, obtaining the result based on the results of the first and second step processes:
1. Analyzing the extracted features by the classification neural network (305);
2. Computing the object features by use of the encoder neural network (309);
3. Product vector representation (310).

Depending on the requirements for system performance and search quality a neural network with ResNet, ResNeXt, MobileNet architecture, etc., can be used as a neural network for image feature extraction.

A network with Mask R-CNN architecture can be used as object detector and classifier, that enables to select contours (“masks”) of different object instances in the images, even if there are several such instances, they have different sizes and are partially overlapped.

LASER library can be used to extract features of a textual description, that enables to use texts in a large number of languages.

Two processes described above result in obtaining two vectors for matching objects from different sources, analyzing the correspondence of the results using a unique set of metrics and substituting the results into the widget.

A method for learning neural networks of the claimed solution is given below.

### Problem Formulation

The task of searching similar goods is limited to the task of searching the nearest vectors in the metric space (kNN—k-nearest neighbors). The tasks of neural networks are to detect objects of interest in images and map each object into a certain vector in space while maintaining similarity. A similar approach is used in face recognition.

### Learning Data

Specially collected and prepared dataset consisting of 2 million images is used for learning. This set of images consists of: photos from websites, Instagram and goods catalogs. Images from goods catalogs are matched with paired images from the other sources. Pairs could be formed both from images of the same products and similar ones. Most of the images have textual descriptions.

Some of these images have been marked with polygonal object masks for object detector learning. Each mask corresponds to an object class. After that, Mask R-CNN-based detector has been learned.

The obtained detector in the claimed solution was used to detect objects in all remaining images. Then, pairs of objects in these images were formed from the pairs of images. A similarity score (rank) corresponds to each pair.

### Neural Network Learning

As can be seen in FIG. 2 and FIG. 3, image processing begins with feature extraction, and this part of the neural network is used in all other steps. It results in additional learning difficulties. For the sake of simplicity, let's first consider the learning of different head parts separately.

### Detector

This part is learned in the usual manner as described in the original article (Mask R-CNN 2017, https://arxiv.org/abs/1703.06870). A subset of masked images is used.

### Classifier

Since all masks also have a class mark, when learning Mask R-CNN, the classifier is also learned. However, for a better classification, the claimed solution uses additional data on the classes of the objects automatically detected. This mode is similar to detector learning, except for the fact that RPN and mask head parts are not learned. The classifier also has access to precomputed features of the object textual description.

Learning to rank The encoder neural network is learned using triplets and triplet loss (FaceNet 2015, https://arxiv.org/abs/1503.03832). Triplets are generated automatically from the existing pairs of objects, taking into account the similarity assessment and state of the neural network. The positive pair is taken from the database, and the negative pair is selected randomly from the search results using the current version of the neural network.

The input data for the encoder neural network are the features of the original image reduced to the object's bounding box (aligned feature maps), object mask and features of the object textual description.

### Image Quality Classifier

This is an auxiliary neural network for binary classification of product images. It is used to select the best quality photo for display. This network is learned on a subset of images marked with binary classes.

### Feature Extraction Training

Learning an image feature extraction neural network for such a variety of applications is not an easy task. The main difficulty is that ranking learning by use of triplets requires three times as much memory. Therefore, a light version of the feature extraction neural network is used at ranking learning.

In general, learning takes place sequentially for different head parts. For each head part, a certain number of steps is performed, then the head part is changed to another one and the process continues.

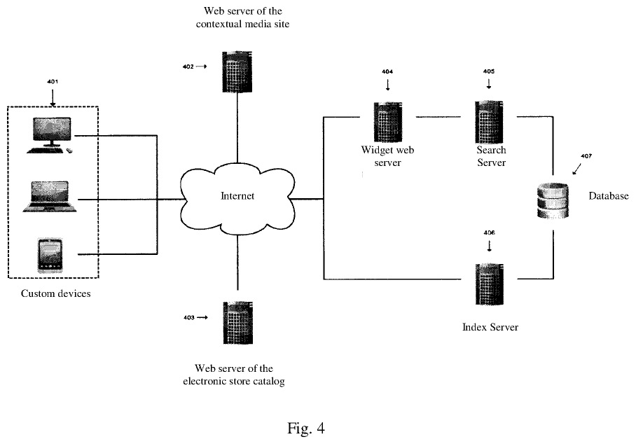

The structure of the claimed solution is illustrated in FIG. 4. The main functional elements are:
1. User devices (401);
2. Web server of the contextual media site (402);
3. Web server of the electronic store catalog (403);
4. Widget generation web server (404);
5. Search Server (405);
6. Index Server (406);
7. Databases (407).

The user device could be a personal computer, smartphone, TV or other devices with the Internet access. The user device generates a request to display a widget, obtains information about the widget contents from the widget web server (404), displays the widget, and keeps interaction between the widget and the user. When choosing goods in the widget, the user is redirected to the web server of the electronic store catalog (403).

The electronic store catalog also serves as a source of information for the index server (406), which periodically updates information about the goods in the database (407). When new goods are detected, the index server analyzes them and computes vector representations for them.

The widget generation takes place on the widget web server side. Several scenarios for widget generation are possible. Let's consider the most typical ones.

### Scenario 1

The widget is embedded into a contextual media site and displays offers of goods associated with the photos on that site.

In this case, the site analysis takes place offline. The search server (405) generates search results for each photo on the site, which are stored in the database (407). When requested to display a widget, the search results come from the database without any resource-intensive processing.

### Scenario 2

The widget is embedded into a site or application and displays offers of goods associated with custom photos that can be generated in real time. In this case, the generation of search results occurs online when the user device accesses to the widget web server. The widget web server accesses to the search server, which performs the process illustrated in FIG. 1. Depending on the type and characteristics of the user device, steps (101)-(105) of the content analysis process could be shifted to the user device side. In this case, the widget web server accepts only vector representations of objects instead of content.

### Scenario 3

The widget is embedded into the video player and is activated when the video is paused or a special button is pressed. In this case, not one image could be analyzed, but a number of frames preceding this event. Subtitles or audio converted into text, for example, could be used as a source of text data. Processing could take place both online and offline. As in the previous case, a significant part of the computational load could be transferred to the user device.

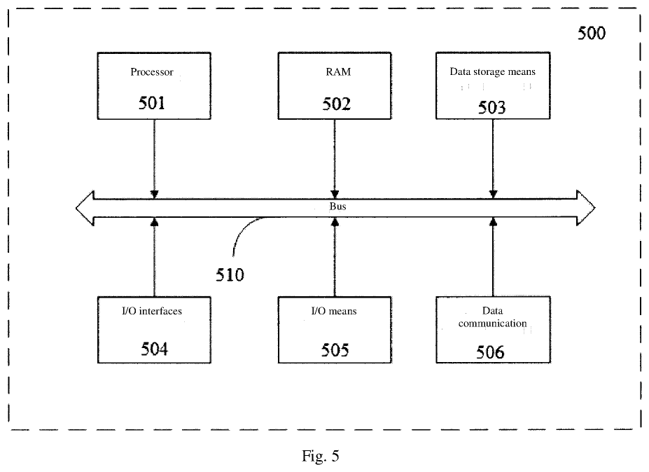

In FIG. 5 hereafter there will be presented the schematic diagram of the computer device (500), processing the data, required for embodiment of the claimed solution.

In general, the device (500) comprises such components as: one or more processors (501), at least one memory (502), data storage means (503), input/output interfaces (504), input/output means (505), networking means (506).

The device processor (501) executes main computing operations, required for functioning the device (500) or functionality of one or more of its components. The processor (501) runs the required machine-readable commands, contained in the random-access memory (502).

The memory (502), typically, is in the form of RAM and comprises the necessary program logic ensuring the required functional.

The data storage means (503) could be in the form of HDD, SSD, RAID, networked storage, flash-memory, optical drives (CD, DVD, MD, Blue-Ray disks), etc. The means (503) enables to store different information, e.g. the above-mentioned files with user data sets, databases comprising records of time intervals measured for each user, user identifiers, etc.

The interfaces (504) are the standard means for connection and operation with server side, e.g. USB, RS232, RJ45, LPT, COM, HDMI, PS/2, Lightning, FireWire, etc.

Selection of interfaces (504) depends on the specific device (500), which could be a personal computer, mainframe, server cluster, thin client, smartphone, laptop, etc.

A keyboard should be used as means of data I/O (505) in any embodiment of the system implementing the described method. There could be any known keyboard hardware: it could be as integral keyboard used in a laptop or netbook, as a separate device connected to a desk computer, server or other computer device. Provided that, the connection could be as hard-wired, when the keyboard connecting cable is connected to PS/2 or USB-port, located on the desk computer system unit, as wireless, when the keyboard exchanges data over the air, e.g. radio channel with a base station, which, in turn, is connected directly to the system unit, e.g. to one of USB-ports. Besides a keyboard the input/output means could also include: joystick, display (touch-screen display), projector, touch pad, mouse, trackball, light pen, loudspeakers, microphone, etc.

Networking means (506) are selected from a device providing network data receiving and transfer, e.g. Ethernet-card, WLAN/Wi-Fi module, Bluetooth module, BLE module, NFC module, IrDa, RFID module, GSM modem, etc. Making use of the means (505) provides an arrangement of data exchange through wire or wireless data communication channel, e.g. WAN, PAN, LAN, Intranet, Internet, WLAN, WMAN or GSM.

The components of the device (500) are interconnected by the common data bus (510).

The application materials have represented the preferred embodiment of the claimed technical solution, which shall not be used as limiting the other particular embodiments, which are not beyond the claimed scope of protection and are obvious to persons skilled in the art.

1. A computer-implemented method for generating search results in an advertising widget, which consists in performing the steps at which the following is performed using at least one neural network (NN):
receiving the image and textual description obtained from the contextual media site;
processing the obtained image of the investigated area by detecting objects in the image, extracting the object features in the image;
analyzing the extracted features, and based on the analysis, selecting the detected objects for dividing them into classes;
extracting the features of a textual description;
computing the vectors corresponding to the objects in the semantic space by use of object features in the image and features of the textual description;
using the obtained combination of vectors for searching relevant goods in electronic store catalogs;
generating search results in an advertising widget.

2. The method according to claim 1, wherein the selection of the detected objects is carried out by bounding boxes.

3. The method according to claim 1, wherein the features of the original image, which are not related to the selected object, are suppressed by selecting the contoured object.

4. The method according to claim 1, wherein the classifiers are formed at the learning step using a learning sample, generating optimal classifiers.

5. The method according to claim 1, wherein a neural network with Mask R-CNN architecture is used to analyze the extracted features.

6. The method according to claim 1, wherein a triplet-learned neural network is used to compute a vector in the semantic space.

7. The method according to claim 1, wherein a neural network is additionally used to classify the image quality.

8. The method according to claim 1, wherein relevant products are displayed to the user with ability to go to a specific product page for purchasing.
